(19) United States
(12) Patent Application Publication
(10) Pub. No.: US 2010/0143025 A1
(43) Pub. Date: Jun. 10, 2010

(54) MULTI-PURPOSED PNEUMATIC TUBE CONNECTOR

(75) Inventor: Tsai-Chao WU, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: CHANTO AIR HYDRAULICS CO., LTD., Taichung City (TW)

(21) Appl. No.: 12/346,406

(22) Filed: Dec. 30, 2008

(30) Foreign Application Priority Data
Dec. 8, 2008 (TW) 97221982

(51) Int. Cl. F15D 1/14

(52) U.S. Cl. 403/32

(57) ABSTRACT

A multi-purposed pneumatic tube connector, which is incorporated in a pneumatic system to create a second passageway, includes a main member and an electromagnetic valve. The main member has a main tunnel, a first tunnel, a second tunnel, an inter-tunnel, and a sub-tunnel. The second tunnel is normally communicated with the main tunnel. The inter-tunnel is communicated with the main tunnel, in which a control end of the electromagnetic valve is inserted. The inter-tunnel is communicated with the first tunnel through the sub-tunnel, and the electromagnetic valve may control the communication of the main tunnel and the first tunnel.

### BACKGROUND OF THE INVENTION

1. Field of the Invention

The present invention relates generally to a pneumatic system, and more particularly to a multi-purposed pneumatic tube connector.

2. Description of the Related Art

Typically, a conventional pneumatic system usually is incorporated with a tube system for transmission of compressed air. There are several devices in the tube system, including redirection device, air filter, lubricator, solenoid valve, and silencer etc. Typically, these devices are in series connection. It is obvious that the more the devices in the tube system, the longer and bigger the tube system will be. Besides, there is more risk of linkage or malfunction in the longer tube system.

### SUMMARY OF THE INVENTION

The primary objective of the present invention is to provide a multi-purposed pneumatic tube connector to create a second passageway in a series pneumatic system.

According to the objective of the present invention, a multi-purposed pneumatic tube connector, which is incorporated in a pneumatic system, includes a main member having a main tunnel, a first tunnel communicated with the main tunnel, and an electromagnetic valve, which is provided on the main member, having an control terminal between the main tunnel and the first tunnel to control whether the main tunnel is communicated with the first tunnel or not.

### BRIEF DESCRIPTION OF THE DRAWINGS

FIG. 1 is a front view of a preferred embodiment of the present invention;

FIG. 2 is a sectional view along the 2-2 line of FIG. 1;

FIG. 3 is a right view of the preferred embodiment of the present invention;

FIG. 4 is a part sectional view of FIG. 3;

FIG. 5 is a front view of the pneumatic system, in which the connector of the preferred embodiment of the present invention is provided; and

FIG. 6 is a top view of FIG. 5.

### DETAILED DESCRIPTION OF THE INVENTION

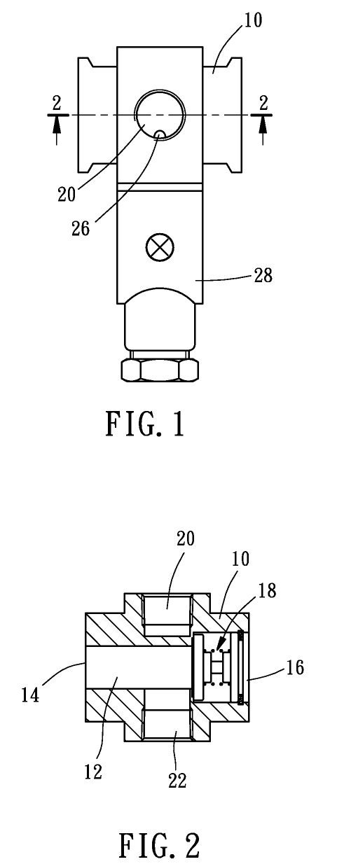

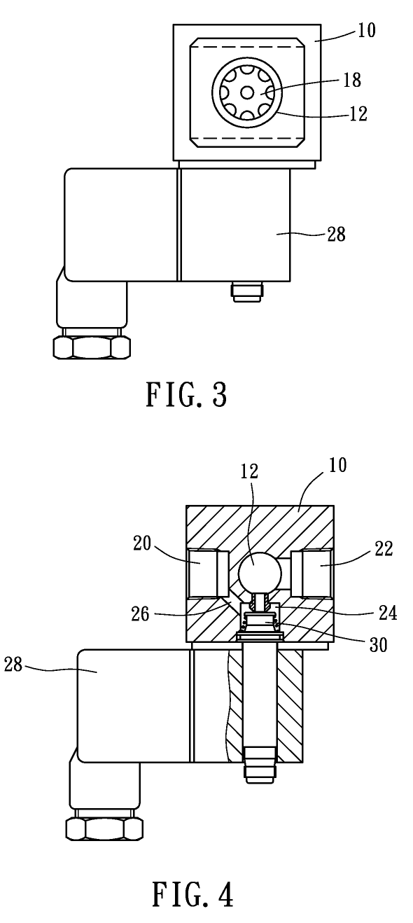

As shown in FIG. 1 to FIG. 4, a multi-purposed connector 100 of the preferred embodiment of the present invention, which is incorporated in a pneumatic system, includes:

A main member 10, which is a metal cube in the present invention, has a transverse main tunnel 12. According to FIG. 2, a left end of the main tunnel 12 is an inlet 14, and a right end thereof is an outlet 16. A check valve 18 is provided in the tunnel 12 closed to the outlet 16. As shown in FIG. 4, the main member 10 has a first tunnel 20 at a front side thereof, a second tunnel 22 at a rear side thereof, and an inter-tunnel 24 at a bottom side thereof. The first tunnel 20 is not communicated with the main tunnel 12 but communicated with the inter-tunnel 24 through a sub-tunnel 26, which is communicated with the main tunnel 12. The second tunnel 22 is communicated with the main tunnel 12 directly.

An electromagnetic valve 28 is provided on the bottom side of the main member 10, which has a control terminal 30 entering the inter-tunnel 24 to control the communication of the main tunnel 12 and the inter-tunnel 24.

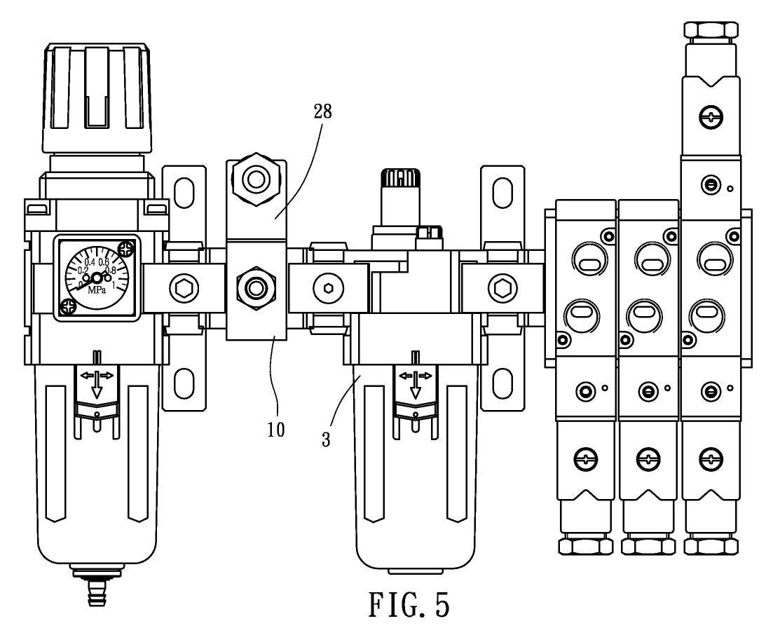

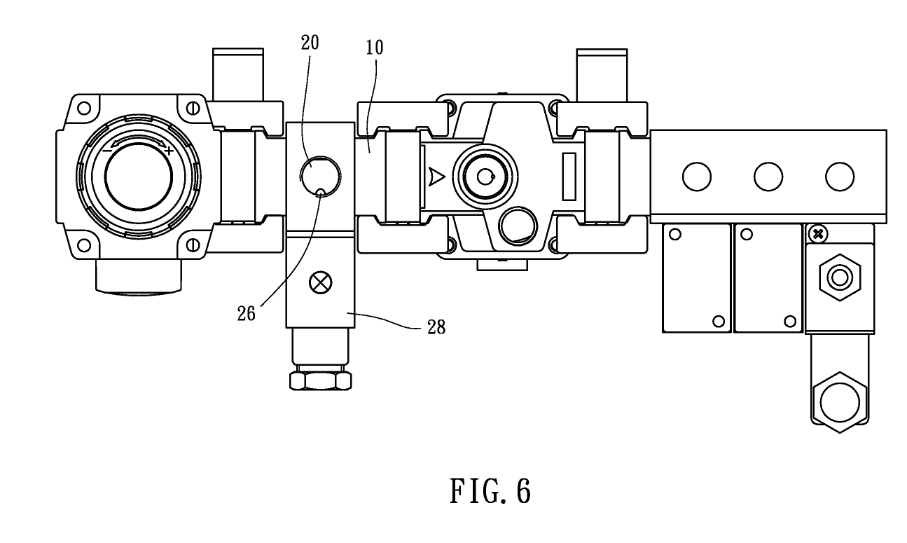

The main member is incorporated in a pneumatic system, as shown in FIG. 5 and FIG. 6, to allow a compressed air flowing through the main tunnel 12 from the inlet 14 to the outlet 16. The check valve 18 allows the compressed air only flowing from the inlet 14 to the outlet 16 that may stop lubrication oil provided by a lubricator 3 flowing backwards. The second tunnel 22 is normally communicated with the main tunnel 12. Usually, an air sprayer (not shown) is connected to the second tunnel 22. An air press (not shown) may be connected to the first tunnel 20, and the electromagnetic valve 28 may control the compressed air in the main tunnel flowing to the air press via the first tunnel 20 or not.

It is obvious that the present invention may reduce the length and the size of the pneumatic system including the redirection device, the electromagnetic valve, and the check valve etc. The present invention may increase connection portions in the pneumatic system that reduces the risk of linkage and malfunction, and the problems of operation and maintain. The connector of the present invention creates a second passageway in a series pneumatic system to provide a flexible application.

The description above is a few preferred embodiments of the present invention and the equivalence of the present invention is still in the scope of the claim of the present invention.

What is claimed is:

1. A multi-purposed pneumatic tube connector, which is incorporated in a pneumatic system, comprising:
a main member having a main tunnel, a first tunnel communicated with said main tunnel; and
an electromagnetic valve, which is provided on said main member, having an control terminal between said main tunnel and said first tunnel to control whether said main tunnel is communicated with said first tunnel or not.

2. The multi-purposed pneumatic tube connector as defined in claim 1, wherein said main member includes an inter-tunnel communicating said main tunnel with said first tunnel, in which said control terminal of said electromagnetic valve is received.

3. The multi-purposed pneumatic tube connector as defined in claim 2, wherein said main member further includes a sub-tunnel between said inter-tunnel and said first tunnel.

4. The multi-purposed pneumatic tube connector as defined in claim 2, wherein said inter-tunnel and said first tunnel are substantially orthogonal.

5. The multi-purposed pneumatic tube connector as defined in claim 1, wherein main member includes a second tunnel communicated with said main tunnel.

6. The multi-purposed pneumatic tube connector as defined in claim 1, further comprising a check valve received in said main tunnel of said main member.
